(19) United States
(12) Patent Application Publication
(10) Pub. No.: US 2003/0220816 A1
(43) Pub. Date: Nov. 27, 2003

(54) System and method for managing interactions between machine-generated and user-defined patient lists

(76) Inventors: Andy Giesler, Madison, WI (US); Ervin Walter, Madison, WI (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/427,262

(22) Filed: Apr. 30, 2003

Related U.S. Application Data
(60) Provisional application No. 60/376,642, filed on Apr. 30, 2002.
(60) Provisional application No. 60/376,587, filed on Apr. 30, 2002.

(51) Int. Cl. G06F 17/60

(52) U.S. Cl. 705/2

(57) ABSTRACT

A method of managing a user-defined patient list in a healthcare setting is provided that includes retrieving a plurality of patients from a repository to create a master patient list; retrieving a machine-generated patient list from a first memory, the machine-generated patient list being derived from the master patient list; and retrieving the user-defined patient list from a second memory, the user-defined patient list being derived from the machine-generated patient list. The method also includes comparing the machine-generated patient list to the user-defined patient list and modifying a patient entry on the user-defined patient list in response to the comparison in order to reconcile a difference between the machine-generated patient list and the user defined patient list.

### CROSS-REFERENCE TO RELATED APPLICATIONS

This application claims priority to U.S. Provisional Application Serial No. 60/376,642, entitled “System and Method for Managing Interactions Between Machine-Generated and User Defined Patient Lists,” filed Apr. 30, 2002 (attorney docket no. 29794/38225), and U.S. Provisional Application Serial No. 60/376,587, entitled “Adaptive Multi-level Decision Support Utility for Determining Appropriate Levels of Service in a Healthcare Delivery Network,” filed Apr. 30, 2002 (attorney docket no. 29794/38461) the disclosures of which are hereby expressly incorporated herein by reference.

### TECHNICAL FIELD

This patent relates to health record management, and more particularly, to a system and method for managing interactions between machine-generated and user-defined patient lists.

### BACKGROUND

The management of the interaction between machine-generated and user-defined patient lists presents a significant challenge to the development of computer software for use in a healthcare information system. In an environment where the machine-generated lists and the user-defined lists both change over time, it is necessary and desirable to retain some or all of the user-defined portions of the user-defined list, and to add and subtract patients from the user-defined list in response to changes that occur in the machine-generated patient lists, as well as according to changes to pre-defined attributes of the patient health record.

At any given moment in time, a healthcare information system has stored in a repository a certain set of data comprised of patient data, healthcare business data, and other forms of data useful for the functioning of the healthcare information system.

From this data, the repository can produce a machine-generated master patient list as well as any number of pre-defined and ad hoc machine-generated patient lists of multiple types, each suited to a particular purpose. Some lists may pertain to part or all of an organizational entity, while others may pertain to particular groups of users, individuals, or particular user roles. In addition, users are then permitted to create user-defined patient lists (using a machine-generated patient list as a basis) suited to particular roles and specific situations. Such a user-defined list is dependent on the composition of both the machine-generated master patient list and the machine-generated patient list from which it was derived. If users are to be allowed to maintain the user-defined portions for these lists, it is necessary to implement a system and method for managing the interaction between machine-generated and user-defined lists as both types of lists change in time, and as the patient records represented on both lists are modified.

Existing systems that include patient list functionality are entirely devoted to machine-generated master lists or machine-generated lists personalized for a particular user, location, organizational entity, or role. In these cases, the individual user does not have a way to add individual patients or groups of patients to a user-defined list derived from a machine-generated list for a particular purpose and have these additions persist when the machine-generated lists change over time, and/or when the patient's data records themselves change.

### SUMMARY

The system and method for managing interactions between machine-generated patient lists and user-defined patient lists includes an architecture of rules and rule relationships that define the content of user-defined lists according to the current machine-generated data, the user-defined data, user-defined system options, and event-driven interactive user choices.

A list manager assists in the reconciliation of machine-generated patient lists with user-defined patient lists when both the machine-generated and user-defined lists change over time, as well as when the patient data for patients represented on these lists change over time. The list manager may provide a method for retaining user-defined list entries over time, even when the patients in question are no longer present in the machine-generated lists.

The exemplary method disclosed herein to manage a user-defined patient list in a healthcare setting includes retrieving a plurality of patients from a health record repository to create a master patient list, wherein each of the plurality of patients have a corresponding electronic medical record. The method also includes retrieving a machine-generated patient list from a first memory, wherein the machine-generated patient list is derived from the master patient list, and retrieving the user-defined patient list from a second memory, wherein the user-defined patient list is derived from the machine-generated patient list. The method may further include comparing the machine-generated patient list to the user-defined patient list and modifying a patient entry on the user-defined patient list in response to the comparison in order to reconcile a difference between the machine-generated patient list and the user defined patient list.

### BRIEF DESCRIPTION OF THE DRAWINGS

FIG. 1 is a block diagram of a general purpose data network.

FIG. 2 is a schematic diagram of an embodiment of a network computer.

FIG. 3 is a schematic diagram of several system components located in a healthcare facility.

FIG. 4 is a block diagram of an embodiment of a list manager.

FIG. 5 is a flowchart describing an embodiment of a sync-driven invocation of a list manager.

FIG. 6 is a flowchart describing a user-driven invocation of a list manager.

FIG. 7 is a flowchart describing an exemplary list manager.

FIG. 8 is a flowchart of an exemplary handheld workflow.

FIG. 9 is a flowchart illustrating the entering of Evaluation and Management values and determining Level Of Service in a charge capture process.

FIG. 10 is a flowchart illustrating an Evaluation and Management calculator in a charge capture process.

FIG. 11 is a flowchart illustrating a patient diagnosis in a charge capture process.

FIG. 12 is a flowchart illustrating the entering of billable procedures in a charge capture process.

FIG. 13 is a flowchart illustrating a review and a charge capture.

FIG. 14 is a flowchart illustrating the entering of additional billing information.

### DETAILED DESCRIPTION

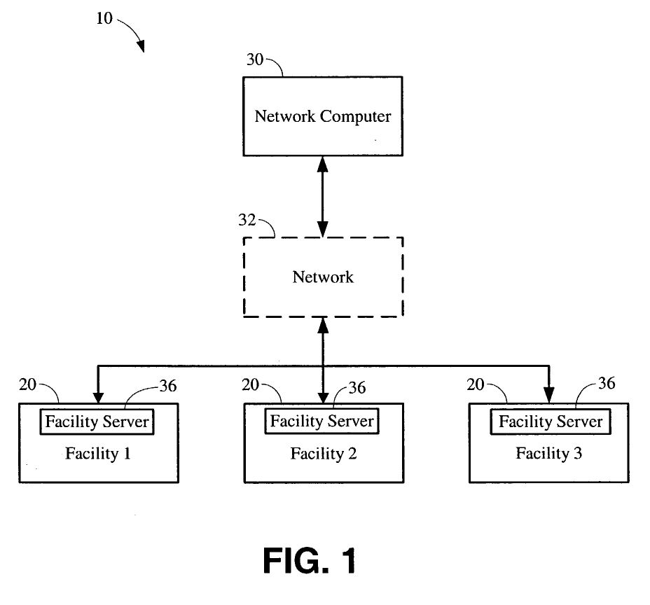

FIG. 1 illustrates a general purpose data network 10 to implement a system for managing the interaction between machine generated patient lists and user-defined patient lists. The data network 10 includes a first group of healthcare facilities 20 operatively coupled to a network computer (i.e. network machine) 30 via a network 32. The plurality of healthcare facilities 20 may be located, by way of example rather than limitation, in separate geographic locations from each other, in different areas of the same city, or in different states.

The network 32 may be provided using a wide variety of techniques well known to those skilled in the art for the transfer of electronic data and may include industry standard network hardware (routers, switches, connectors, etc.) and software (network and communication protocols). For example, the network 32 may take the form of a cable-based or fiber optic network, a wireless local area network (LAN), a wireless wide area network (WWAN), a virtual private network (VPN), the Internet, or any other type of wired or wireless network that allows communication between computing devices. Additionally, the network 32 may include a plurality of network computers or server computers (not shown), each of which may be operatively interconnected in a known manner.

The network computers may be used to facilitate communication between an end-user client application and a patient health record repository, including but not limited to web servers, gateway servers, application servers, terminal servers, and database servers. Data communication may take place over the network 32 via an Internet communication protocol.

The network computer 30 may be a server computer of the type commonly employed in networking solutions. The network computer 30 may be used to accumulate, analyze, and download data relating to a healthcare facility's medical records. For example, the network computer 30 may periodically receive data from each of the healthcare facilities 20 indicative of information pertaining to a patient's medical record, billing information, employee data, etc. The healthcare facilities 20 may include one or more facility servers 36 that may be utilized to store information for a plurality of patients/employees/accounts/etc. associated with each facility.

Although the data network 10 is shown to include one network computer 30 and three healthcare facilities 20, it should be understood that different numbers of computers and healthcare facilities may be utilized. For example, the network 32 may include a plurality of network computers 30 and dozens of healthcare facilities 20, all of which may be interconnected via the network 32. According to the disclosed example, this configuration may provide several advantages, such as, for example, enabling near real time uploads and downloads of information as well as periodic uploads and downloads of information. This provides for a primary backup of all the information generated in the process of updating and accumulating healthcare data.

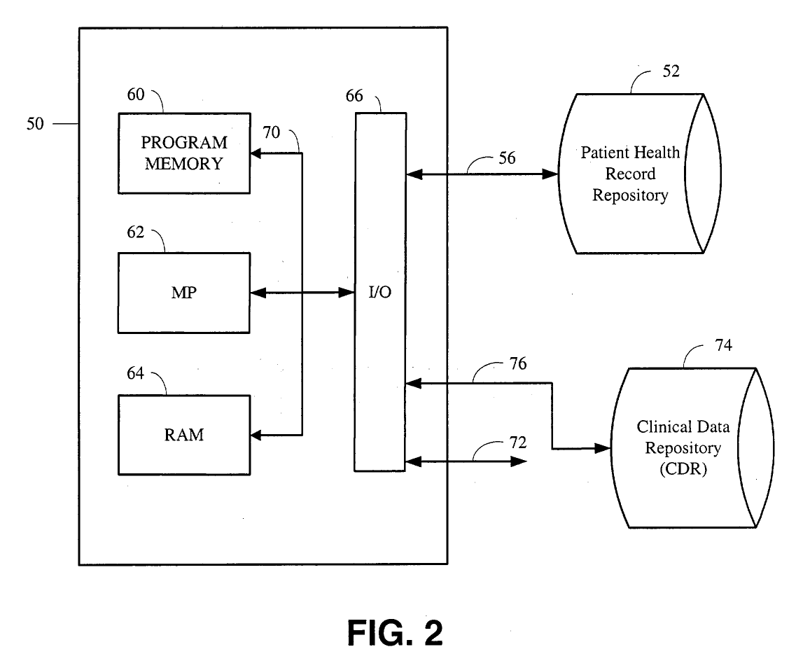

FIG. 2 is a schematic diagram of one possible embodiment of the network computer 30 shown in FIG. 1. The network computer (i.e. machine) 30 may have a controller 50 that is operatively connected to a health record repository 52 via a link 56. The health record repository may include one or more databases or data repositories that store patient healthcare data and related healthcare business data using one or more database management systems that run on one or more computing platforms on one or more computing devices.

The controller 50 may include a program memory 60, a microcontroller or a microprocessor (MP) 62, a random-access memory (RAM) 64, and an input/output (I/O) circuit 66, all of which may be interconnected via an address/data bus 70. It should be appreciated that although only one microprocessor 62 is shown, the controller 50 may include multiple microprocessors 62. Similarly, the memory of the controller 50 may include multiple RAMs 64 and multiple program memories 60. Although the I/O circuit 66 is shown as a single block, it should be appreciated that the I/O circuit 66 may include a number of different types of I/O circuits. The RAM(s) 64 and programs memories 60 may be implemented as semiconductor memories, magnetically readable memories, and/or optically readable memories, for example. These various types of memories may also be referred to as machine-accessible mediums. The controller 50 may also be operatively connected to the network 32 via a link 72, as well as a Clinical Data Repository (CDR) 74 via a link 76.

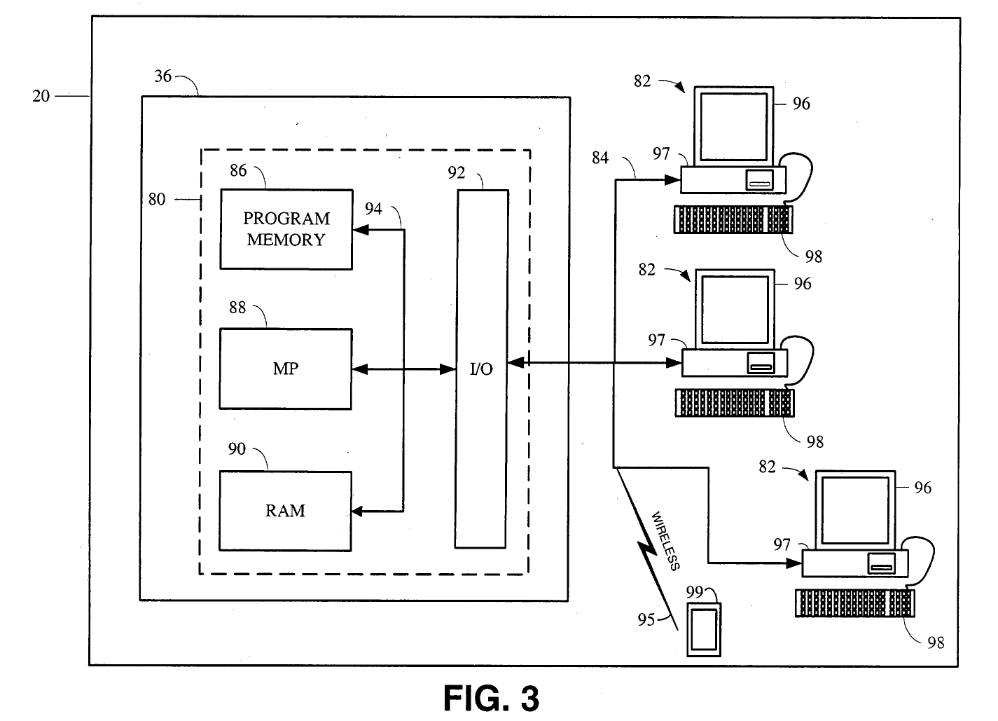

FIG. 3 is a schematic diagram of one possible embodiment of several components located in one or more of the healthcare facilities 20 from FIG. 1. Although the following description addresses the design of the healthcare facilities 20, it should be understood that the design of one or more of the healthcare facilities 20 may be different than the design of other healthcare facilities 20. Also, each healthcare facility 20 may have various different structures and methods of operation. It should also be understood that the embodiment shown in FIG. 3 illustrates some of the components and data connections present in a healthcare facility, however it does not illustrate all of the data connections present in a typical healthcare facility. For exemplary purposes, one design of a healthcare facility is described below, but it should be understood that numerous other designs may be utilized.

The healthcare facilities 20 may have a facility server 36, which includes a controller 80, wherein the facility server 36 is operatively connected to a plurality of client device terminals 82 via a network 84. The network 84 may be a wide area network (WAN), a local area network (LAN), a wireless wide area network (WWAN), a virtual private network (VPN), the Internet, or any other type of network readily known to those persons skilled in the art. The client device terminals 82 may also be operatively connected to the network computer 30 from FIG. 1 via the network 32.

Similar to the controller 50 from FIG. 2, the controller 80 may include a program memory 86, a microcontroller or a microprocessor (MP) 88, a random-access memory (RAM) 90, and an input/output (I/O) circuit 92, all of which may be interconnected via an address/data bus 94. As discussed with reference to the controller 50, it should be appreciated that although only one microprocessor 88 is shown, the controller 80 may include multiple microprocessors 88. Similarly, the memory of the controller 80 may include multiple RAMs 90 and multiple programs memories 86. Although the I/O circuit 92 is shown as a single block, the I/O circuit 92 may include a number of different types of I/O circuits. The RAM(s) 90 and programs memories 86 may also be implemented as semiconductor memories, magnetically readable memories, and/or optically readable memories, for example.

The client device terminals 82 may include a display 96, a controller 97, a keyboard 98 as well as a variety of other input/output devices (not shown) such as a printer, mouse, touch screen, track pad, track ball, isopoint, voice recognition system, etc. A few examples of client device terminals include workstations, handheld computing devices, laptop computing devices, and web appliances. For example, a handheld computing device 99 may be included that includes a wireless connection 95. The handheld computing device 99 may communicate wirelessly with the Patient Health Record Repository 52 via a gateway server (not shown) which in turn communicates with the Patient Health Record Repository's server (not shown). The handheld computing device 99 may also communicate with the Patient Health Record Repository 52 by connecting to one of the workstations 82 via a sync cradle, which provides the ability to connect to the Patient Health Record Repository 52 through a gateway server (not shown) and the Patient Health Record Repository's server (not shown).

Each client device terminal 82 may be signed onto and occupied by a healthcare employee to assist them in performing their duties. Healthcare employees may sign onto a client device terminal 82 using any generically available technique, such as entering a user name and password. If a healthcare employee is required to sign onto a client device terminal 82, this information may be passed via the link 84 to the facility server 36, so that the controller 80 will be able to identify which healthcare employees are signed onto the system and which client device terminals 82 the employees are signed onto. This may be useful in monitoring the healthcare employees' productivity.

Typically, facility servers 36 store a plurality of files, programs, patient lists, and other data for use by the client device terminals 82 and the network computer 30. One facility server 36 may handle requests for data from a large number of client device terminals 82. Accordingly, each facility server 36 may typically comprise a high end computer with a large storage capacity, one or more fast microprocessors, and one or more high speed network connections. Conversely, relative to a typical facility server 36, each client device terminal 82 may typically include less storage capacity, a single microprocessor, and a single network connection.

### Overall Operation of the System

One manner in which an exemplary system may operate is described below in connection with a block diagram and a number of flow charts which represent a number of portions or routines of one or more computer programs. These computer program portions may be stored in one or more of the memories in the controllers 50 and 80, and may be written at any high level language such as C, C++, or the like, or any low-level, assembly or machine language. By storing the computer program portions therein, various portions of the memories are physically and/or structurally configured in accordance with the computer program instructions.

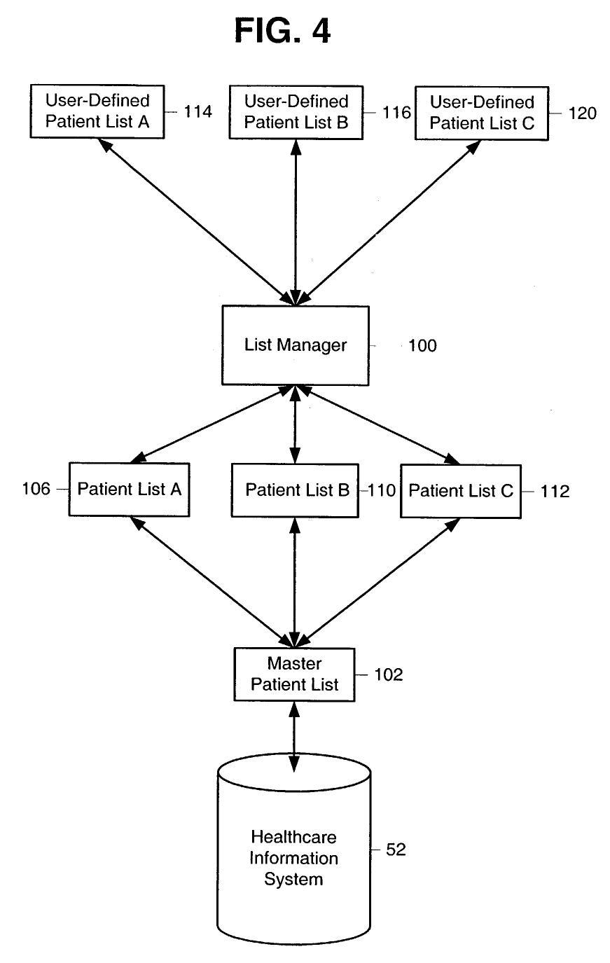

FIG. 4 illustrates a block diagram of a list manager 100 that serves as an integral part of a healthcare information system. The list manager 100 mediates the relationship between a machine-generated master patient list 102 derived from information stored in the patient health record repository 52, one or more machine-generated patient lists, such as machine generated patient lists 106, 110 and 112, which are derived from the master patient list 102, and one or more user-defined patient lists, such as user defined patient lists 114, 116, and 120. The user-defined lists 114, 116, and 120 are based on a machine-generated patient list and are constructed according to one or more predefined patient attributes and one or more predefined user attributes.

A given machine-generated patient list may serve as the basis for a given user-defined list. For example, the machine generated patient list 106 may serve as the basis for the user-defined patient list 114. The list manager 100 allows the user to add patients to the corresponding user-defined lists by selecting patients available on the master patient list 102. The user can also remove patients from a user-defined list.

In addition, the list manager 100 may control the reconstruction of the user-defined lists 114, 116, and 120 when the user manually resets a user-defined list, when a user-defined list changes in relation to its corresponding machine-generated patient list, and when a machine-generated patient list changes in relation to its corresponding user-defined list. The list manager 100 functions so that a user's changes to a given user-defined list can be retained over time within the context of changes to its corresponding machine-generated patient list and in relation to the machine-generated master patient list 102.

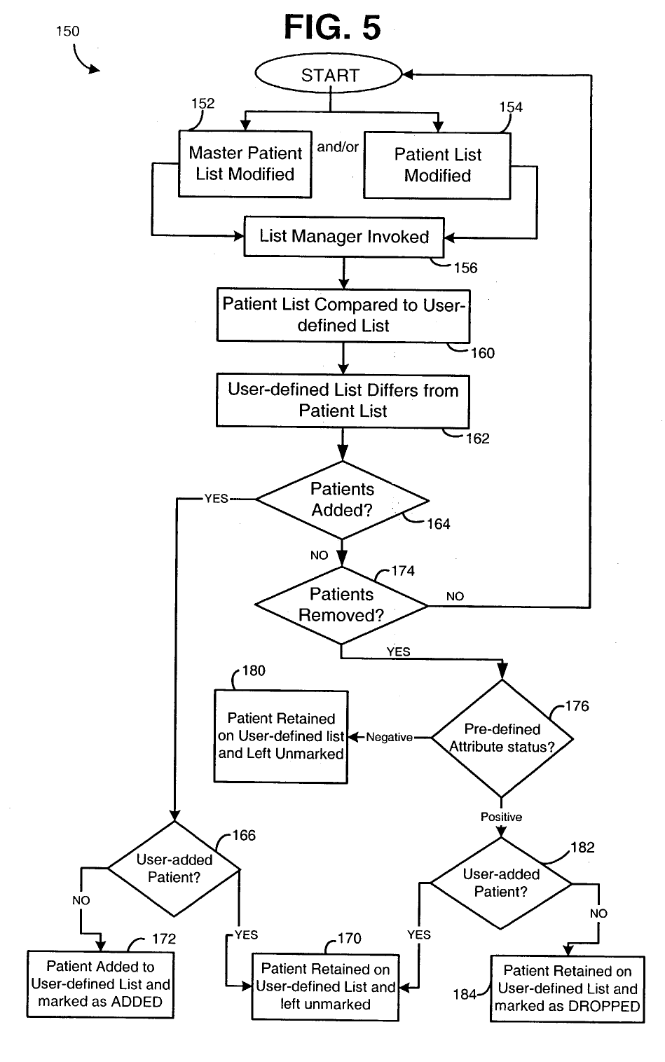

FIG. 5 is a flow chart 150 describing a sync-driven invocation of the list manager 100. The invocation of the list manager 100 is said to be sync-driven when it is invoked in response to a user syncing the handheld computing device 99. If after a sync has been performed with the handheld computing device 99, it is determined that the machine-generated master patient list 102 and/or a machine-generated patient list (from which a user-defined patient list is derived) was modified (blocks 152, 154), the list manager 100 may be invoked (block 156) to compare the appropriate patient list with its corresponding user-defined list (block 160) in order to determine whether the user-defined list differs from the patient list (block 162). If the user-defined list does differ from the patient list, the list manager 100 may examine each point of difference to determine whether patients have been added from the patient list in relation to the user-defined list (block 164).

If it is determined at the block 164 that a patient has been added to the patient list that is not represented on the user-defined list, the list manager 100 may determine whether the patient has already been added to the user-defined list by the user (block 166). If the patient has been added by the user to the user-defined list, the patient is retained and a visual marker associated with the user is not modified (block 170). If it is determined at the block 166 that the patient has not previously been added to the user-defined list by the user, the patient may be added to the user-defined list and marked visually to indicate to the user that the patient has been added (block 172).

If it is determined at the block 164 that patients were not added, the list manager 100 may determine if patients were removed from the patient list (block 174). If it is determined at the block 174 that a patient has been removed from the patient list that is represented on the user-defined list, the list manager 100 may first determine the status of certain pre-defined attributes stored in the patient record (block 176). If the status is negative, the patient may be retained on the user-defined list and marked visually to indicate to the user that the patient has a positive status (block 180). If it is determined at the block 176 that the status is positive, the list manager 100 may then determine whether the patient has been added to the user-defined list by the user (block 182). If the patient was added by the user to the user-defined list, the patient is retained (block 170). If the patient was not added to the user-defined list by the user, the patient may be retained on the user-defined list and marked visually to indicate to the user that the patient is no longer represented on the patient list from which the user-defined list is derived (block 184).

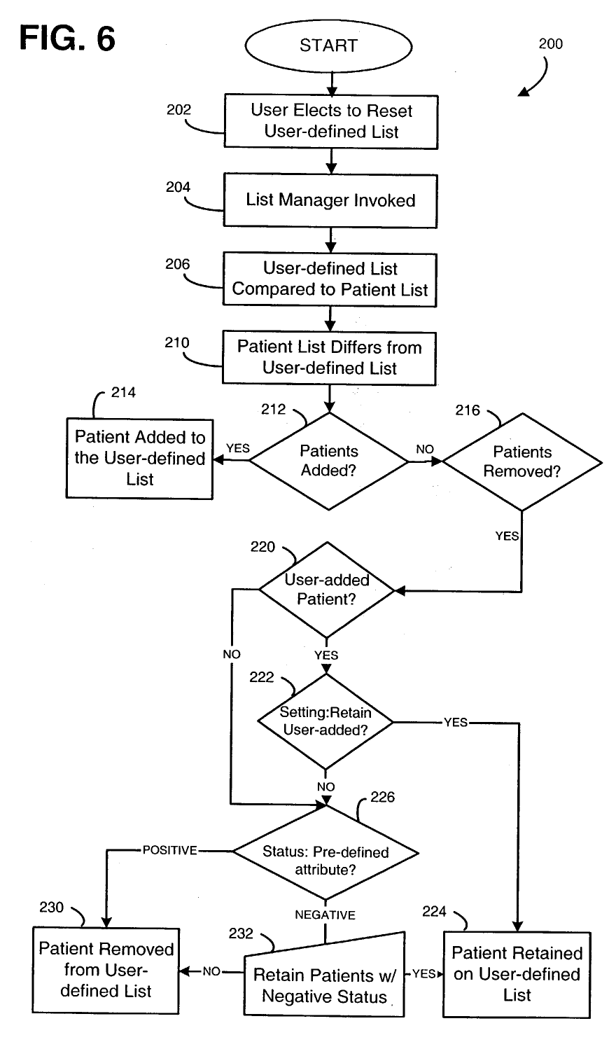

FIG. 6 is a flow chart 200 describing a user-driven invocation of the list manager 100. The invocation of the list manager 100 is said to be user-driven when it is invoked in response to events generated by the user, such as user choice or user input. When a user elects to reset his user-defined list (block 202), the list managed may be invoked (block 204) to compare the appropriate user-defined list with its corresponding patient list (block 206) in order to determine whether the patient list differs from the user-defined list (block 210). If it is determined at a block 212 that a patient that has been added to the patient list is not represented on the user-defined list, the patient may be automatically added to the user-defined list (block 214). If it is determined at the block 212 that a patient was not added to the user-defined list, the list manager 100 may check at a block 216 to determine if a patient was removed from the user-defined list. If it is determined at the block 216 that a patient has been removed from the patient list that is represented on the user-defined list, the list manager 100 may determine whether the patient was added to the user-defined list by the user (block 220). The list manager 100 may then evaluate a system-level setting that indicates whether user-added patients should be automatically retained regardless of their status and regardless of whether they are represented on the user-defined list's corresponding patient list (block 222).

If the patient has been added to the user-defined list by the user and the system is configured to retain user-added patients, the patient may be retained on the user-defined list (block 224). If the patient has been added to the user-defined list by the user and the system is not configured to retain user-added patients, the list manager 100 may evaluate the status of certain pre-defined attributes within the patient record (block 226). If the status of the pre-defined attributes is positive, the patient may be removed from the user-defined list (block 230). If the status of the pre-defined attributes is negative, the list manager 100 may query the user to determine whether the user wants to retain the patient (block 232). If the user assents, the patient may be retained on the user-defined list; if the user does not assent, the patient may be removed from the user-defined list.

If it is determined at the block 220 that the patient has not been added to the user-defined list by the user, but rather as a result of the patient's presence on the machine-generated patient list, the list manager 100 may evaluate the status of certain pre-defined attributes within the patient record (block 226). If the status of the predefined attributes is positive, the patient may be removed from the user-defined list (block 230). If the status of the pre-defined attributes is negative, the list manager 100 queries the user to determine whether the user wants to retain the patient (block 232). If the user assents, the patient may be retained on the user-defined list; if the user does not assent, the patient may be removed from the user-defined list.

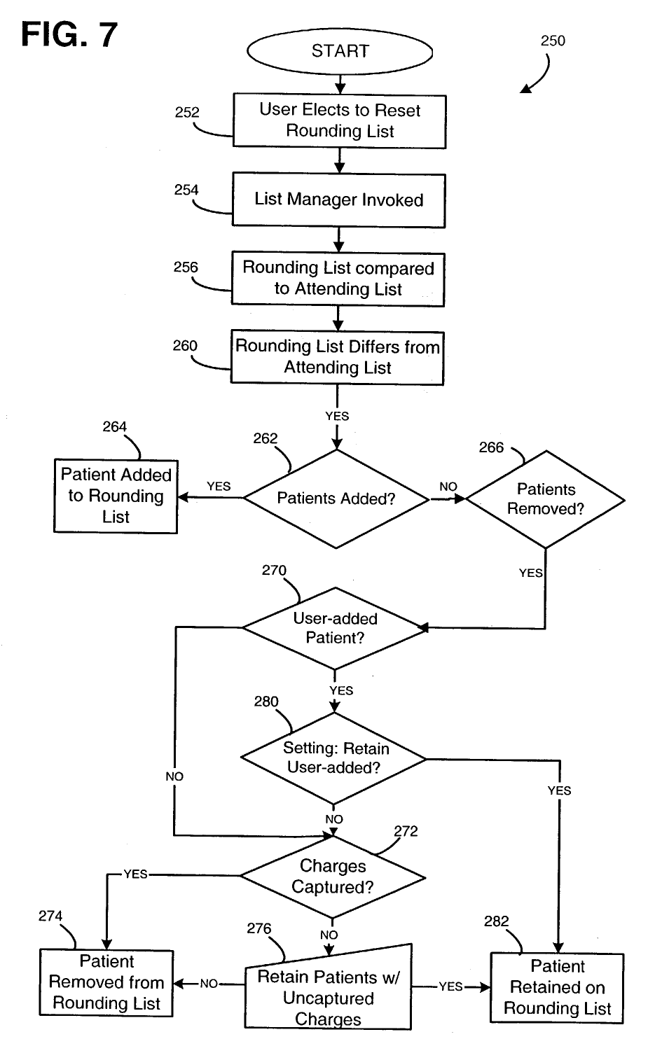

FIG. 7 is a flowchart 250 describing an exemplary list manager 100. In this example, the machine-generated master patient list comprises a hospital census that includes all the patients currently admitted to the hospital. The machine-generated patient list includes an attending provider list, defined as a list of patients for whom a given provider acts as an attending provider. The user-defined list, in this example, includes a personal rounding list for a given provider, defined as a list of patients that the provider in question may see while performing daily rounds. The user-defined list may be based on the attending provider list for the provider in question. The provider in question can then add patients to the rounding list by selecting them from the current hospital census. For example, if the provider is required to act as a consultant for a patient that is not represented on that provider's attending list, the provider can add that patient to the rounding list. The provider can also remove patients from the rounding list, even if they are not user-added patients.

As the provider's rounding list, the hospital census, and therefore the attending list change over time, the hospital census and the provider's attending list are no longer synchronized with the provider's personalized rounding list. When the provider's personal rounding list is no longer synchronized with the provider's census-derived attending list, the user can invoke the list manager 100 in order to reconcile the rounding list with the attending list (block 252) while retaining some or all of the user-added patients on the rounding list. The list manager 100 can also be invoked by a machine-generated process outside of the provider's immediate control.

When the list manager 100 is invoked (block 254), it may determine whether the attending list and the rounding list for the provider in question require synchronization. If so, the list manager 100 may compare the attending list with the rounding list (block 256), patient by patient, and determine whether there are patients on the attending list that are not on the rounding list (block 260). If it is determined at a block 262 that this is the case, the list manager 100 may add each of these patients to the rounding list (block 264). The list manager 100 may then determine whether there are patients on the rounding list that are not on the attending list (block 266). If it is determined at the block 266 that this is the case, the list manager 100 may determine at a block 270 whether each of these patients is user-added. If the patient is not user-added, the list manager 100 may determine at a block 272 whether or not a given patient has charge that has been captured and removes those patients that do not have outstanding charges to be captured. The list manager 100 may also remove the patients that have charges that have been captured if the provider assents to this action (block 274). Otherwise, the patients that have charges that have not been captured may be retained on the rounding list (block 276).

If the list manager 100 determines at a block 280 that all user-added patients present in the provider's rounding list, regardless of whether they are present in the provider's attending list, are to be retained, the list manager 100 may retain the remaining patients and the synchronization process is complete (block 282). If the list manager 100 has not been configured to retain all user-added patients on the rounding list, it then may determine whether a charge has been captured for a given patient (block 272). If the provider chooses to retain patients that have charges that have not been captured, the list manager 100 may retain such patients (block 276), but remove those user-added patients that do not have charges to be captured (block 274).

The list manager 100 may include at least one system setting that indicates whether the list manager 100 should retain user-added patients regardless of their status. The list manager 100 may also include the ability to evaluate patients according to at least one predefined attribute and to derive a status for each patient from the condition of the attribute or attributes.

A component may be included in the list manager 100 that allows the list manager 100 to query the user regarding the action that may be taken for patients with a negative status, and wherein the result of the user query partially determines whether the list manager 100 retains a given patient on the user-defined list. The list manager 100 may use a logical method for the reconciliation and synchronization of machine-generated and user-defined patient lists when the user-defined list and the machine-generated lists are no longer synchronized. The logical method for the reconciliation and synchronization can be invoked by machine-generated processes, by user-generated events, or a combination of the two. Each patient on the user-defined list may be evaluated to determine whether the patient is a user-added patient and whether the patient's status is derived from a predefined attribute or a set of attributes. Patients on the user-defined list may be marked for retention or removal according to a combination of factors, including but not limited to whether the patient is a user-added patient, whether the system setting is set to retain user-added patients, whether the patient's status is negative or positive, and whether the user elects to retain patients with a negative status.

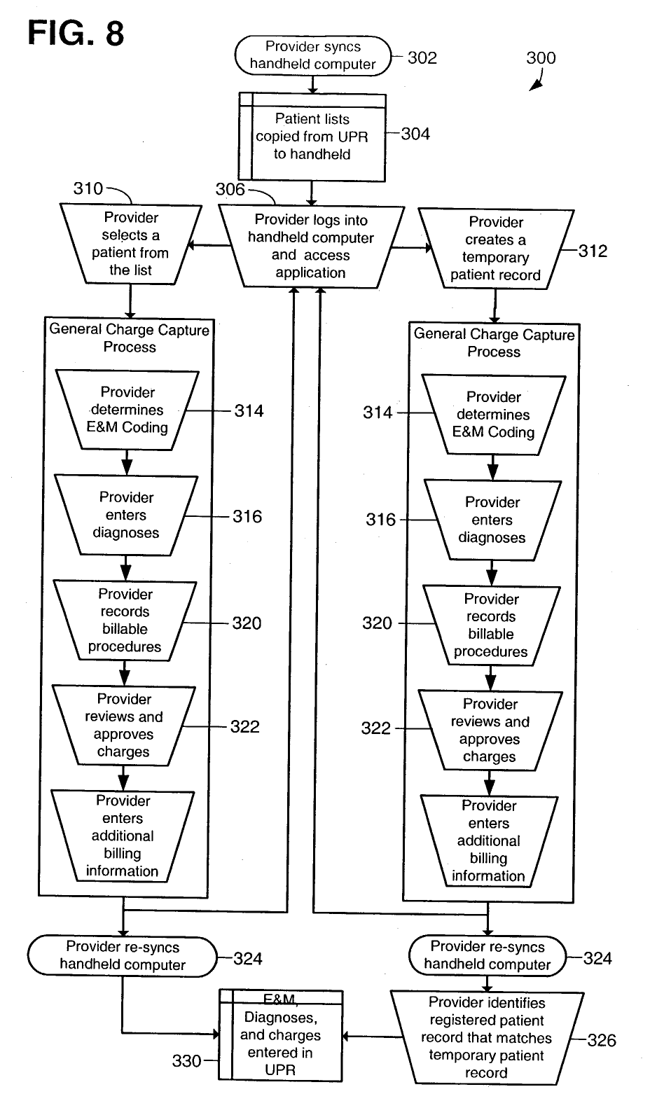

FIG. 8 illustrates a flowchart 300 of an exemplary handheld workflow. The system disclosed in FIG. 8 is not dependant on a continuous connection to the server 36, or the CDR 74 residing on the server 36. In general usage, a provider synchronizes the data on the handheld computing device 99 with the CDR (block 302), and loads a set of patients into the memory on the handheld 99 (block 304). This set may be based on the provider's schedule, the patients located in a certain physical or organizational location, those patients typically treated by the provider, or any other set of patients. In general, the set of patients should correspond to the patients the provider is likely to treat while using the handheld 99.

After the handheld 99 is disconnected from the CDR 74, the provider logs into a software application implementing the described method, which is run on the handheld 99 (block 306). The method is adaptable to virtually any commercially available handheld unit, which typically includes a processor, program memory, RAM, a user interface and an operating system. The software application may be stored in the program memory to cause the processor to operate in accordance with the herein described method and workflow.

After providing the service, the provider accesses a patient record. If the patient is included in the set of patients loaded to the handheld, the provider simply selects that patient and proceeds with the charge capture process (block 310). If the patient is not in the pre-loaded set of patients, the provider creates a temporary record for the new patient and then begins capturing charges. The temporary patient record contains sufficient patient-identifiable information so that the provider can locate the patient's record in the CDR when re-syncing the handheld.

The charge capture process allows the provider to enter the information necessary to correctly generate charges for billable procedures. Although there is a generally recognized order to entering the information, the provider can enter the sets on information in any order and can switch between interfaces used to enter the data at will. The four elements of the charge capture process shown are as follows: (1) the provider determines the Level Of Service (LOS) based on the E & M coding, length of time spent with the patient, and amount of counseling provided in that time (block 314); (2) the provider enters diagnoses for the patient (block 316); (3) the provider specifies which procedures were performed for the patient, if any (block 320); and (4) the provider reviews the information entered and approves the charges (block 322).

Following the charge capture process, the provider may select another patient (block 310), perform some other action using the handheld, or re-synchronize the data on the handheld with the CDR (blocks 324).

When re-synchronizing the data, the provider associates each temporary patient record with a Universal Patient Record (UPR) in the CDR (block 326). The charges captured on the handheld 99 are added as a contact to the UPR (block 330).

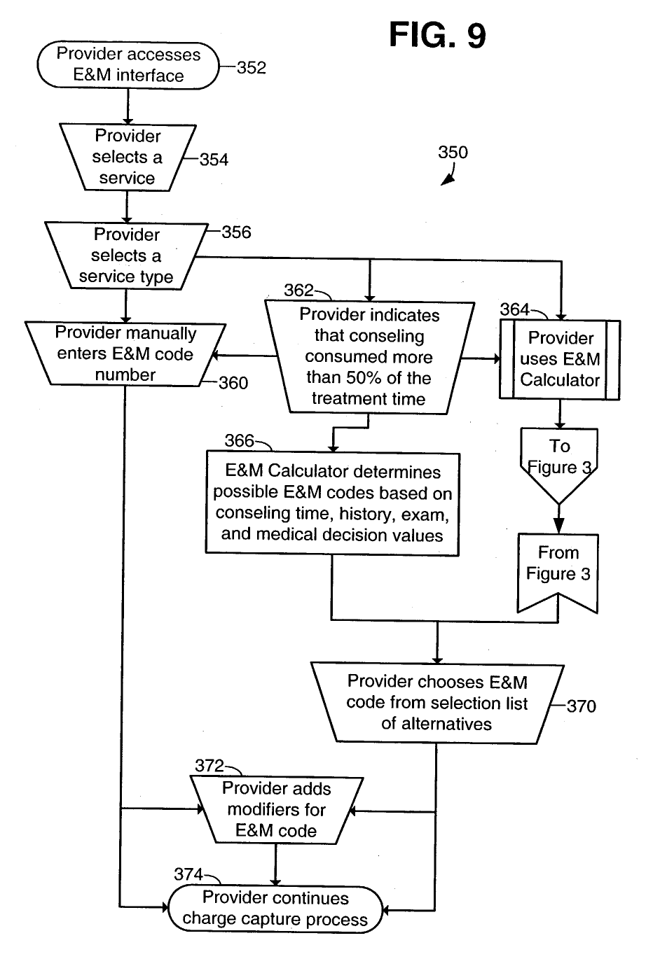

FIG. 9 is a flowchart 350 illustrating the entering of Evaluation and Management (E & M) values and determining Level Of Service (LOS) in the charge capture process. After accessing the E & M interface (block 352), the provider selects the general category of service being provided (block 354). Based on the service, the provider selects a service type (block 356). Service types are subcategories of services, and the provider's options for selecting a service type are limited to those service types listed for the selected service.

Next, the provider enters an E & M code (block 360). If the provider is certain which E & M code applies to the provider's treatment of the patient, the provider can realize maximum efficiency by entering that code. However, the provider may not know the code and the workflow allows the provider to calculate it.

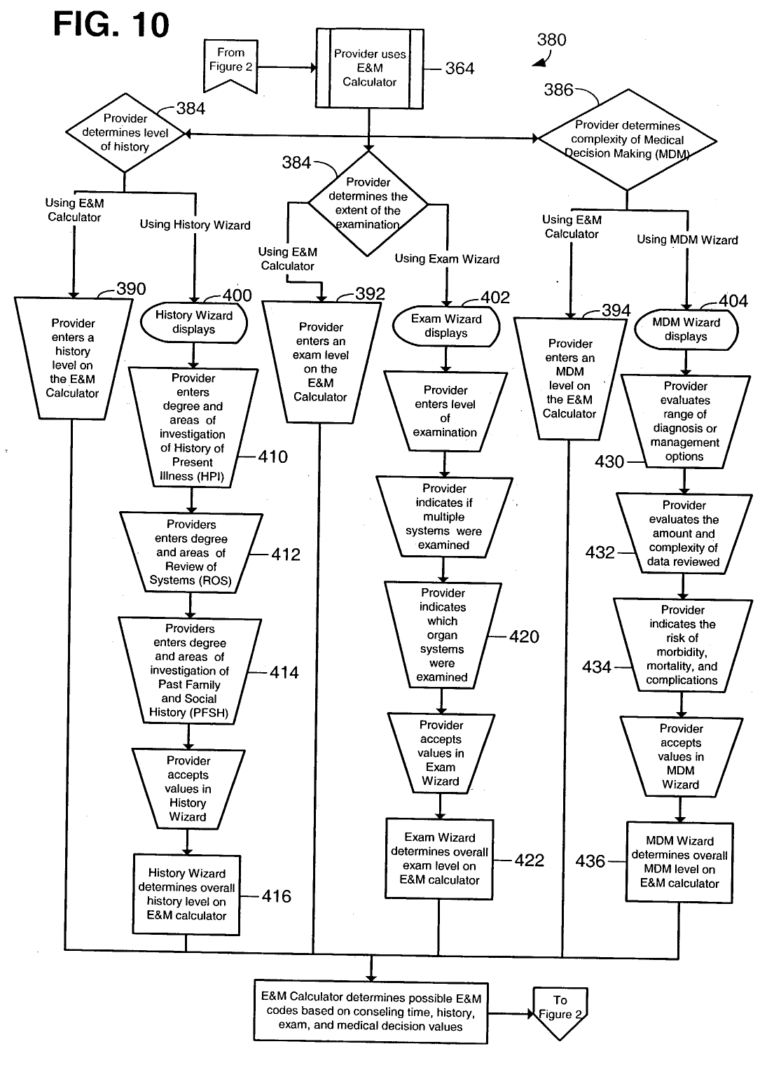

The first step in calculating the E & M code is to determine whether a level of service can be selected strictly based on the amount the provider spent with the patient (blocks 362-366). If the provider does not enter an E & M code, the next step in calculating the E & M code is to use the E & M Calculator, as diagramed in FIG. 10.

Once the E & M Calculator has been used to determine an E & M code, the code can be selected (block 370), a modifier to the code can be applied (block 372), and the provider can continue with the charge capture process (block 374).

FIG. 10 is a flowchart 380 illustrating an exemplary patient diagnosis in a charge capture process. The E & M code is primarily based on three criteria: (1) depth of patient history reviewed (block 382); (2) thoroughness of examination (block 384); and (3) complexity of Medical Decision-Making (MDM) (block 386).

Each criterion has four levels, with increasing requirements for each higher level. The E & M Calculator presents a grid interface with the criteria listed for each row, and the level marked in the cells (the columns represent the increasing levels). The provider may then select one cell in each row, indicating the levels of history (block 390), examination (block 3392), and decision-making (block 394).

Each row also has an option to access a wizard interface for more exactly determining the correct level of each E & M criterion (blocks 400-404). For entering the depth of the review of the patient's history, the provider may select one of the following levels in the E & M Calculator: (1) problem focused; (2) expanded problem focused; (3) detailed; and (4) comprehensive.

If the provider is uncertain as to which level is correct, the multi-level History Wizard can be accessed. The History Wizard guides the provider through the selection of the appropriate levels of these sub-criteria: (1) History of Present Illness (HPI) (block 410); (2) Review Of Systems (ROS) (block 412); and (3) Past, Family and/or Social History (PFSH) (block 414).

For each of the above criteria, if the provider is uncertain which to select, an additional level of support in the wizard is provided. This allows the user to indicate which specific history areas were discussed with the patient. Based on what the provider indicates, the wizard will select the appropriate level for the appropriate sub-criteria (block 416). Once the sub-criteria are entered, the history value is computed and entered in the E & M Calculator.

For entering the thoroughness of the examination of the patient (block 392), the provider may select one of the following levels in the E & M Calculator: (1) problem focused; (2) expanded problem focused; (3) detailed; (4) comprehensive.

If the provider is uncertain as to which level is correct, the Exam Wizard can be accessed (block 402). The Exam Wizard prompts the provider to indicate which body areas and organ systems were examined (block 420), and calculates the exam value based on the provider's input. Once the exam value is computed, it is entered in the E & M Calculator (block 422).

For entering the complexity of the provider's medical decision making, the provider may select one of the following levels in the E & M Calculator (block 394): (1) straightforward; (2) low complexity; (3) moderate complexity; (4) high complexity.

If the provider is uncertain as to which level is correct, the MDM Wizard can be accessed (block 404). The MDM Wizard guides the provider through the selection of the appropriate levels of these sub-criteria: (1) number of diagnoses or management options (block 430); (2) amount and/or complexity of data to be reviewed (block 4432); and (3) risk of complications and/or morbidity or mortality (block 434). Once the sub-criteria are entered, the MDM value is computed and entered in the E & M Calculator (block 436). When all values are entered into the E & M Calculator, the E & M code is determined in accordance with HCFA guidelines, based on the provider's input.

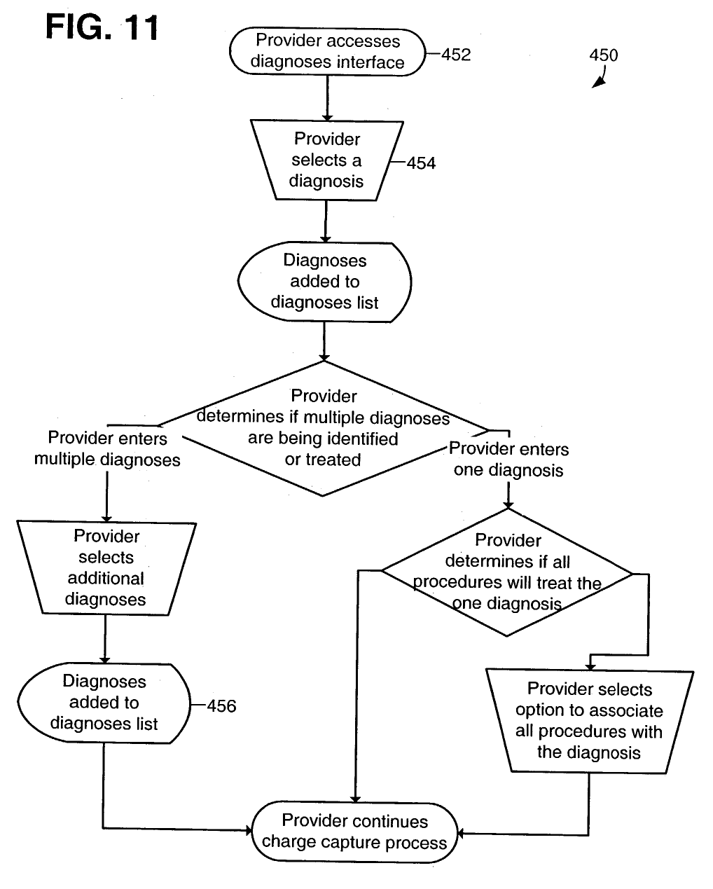

FIG. 11 is a flowchart 450 illustrating a patient diagnosis in a charge capture process. As a part of the charge capture process, the provider accesses the interface used to enter diagnoses for the patient (block 452). The interface allows the provider to select a diagnosis from a selection list (block 454). The provider can choose to have the selected diagnoses automatically be associated with any procedures performed. Alternatively, the system may be configured to require the user to select a plurality of diagnoses, and then decide which diagnosis to associate with a procedure as procedures are selected.

Procedures can be associated with diagnoses in any number of ways. It is to be understood that a diagnosis could pull from the procedures, a diagnosis could be applied forward to every procedure, or any of a number of other methods as long as a link is established between the diagnoses and procedures. The provider can also add additional diagnoses to a list of diagnoses for the patient (block 456).

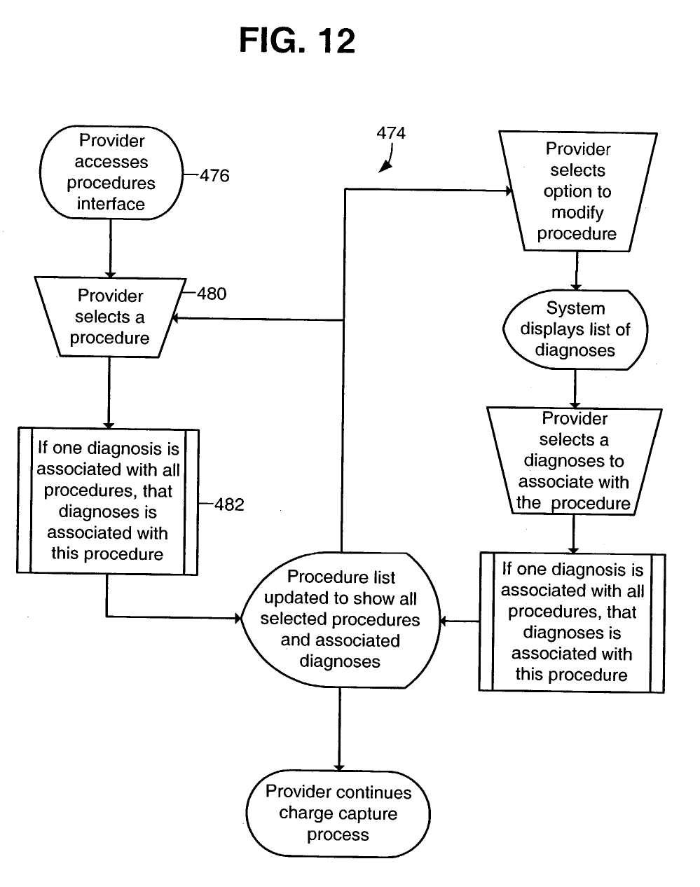

FIG. 12 is a flowchart 474 illustrating the entering of billable procedures in a charge capture process. As a part of the charge capture process, the provider accesses the interface used to record procedures performed as a part of the patient's care (block 476). The interface presents a list of procedures, from which the provider selects a procedure (block 480). The list of procedures may be generated by selecting them from a preference list loaded onto the handheld 99 for the particular provider.

For each procedure listed, the provider can select a procedure and associate it with a diagnosis. If the provider had previously entered a single diagnosis and selected the option to associate it with all procedures, this is done automatically (block 482). If multiple diagnoses were entered, the provider can select which diagnoses are associated with which procedure. Note that the provider may return to the diagnosis interface to add additional diagnoses as needed.

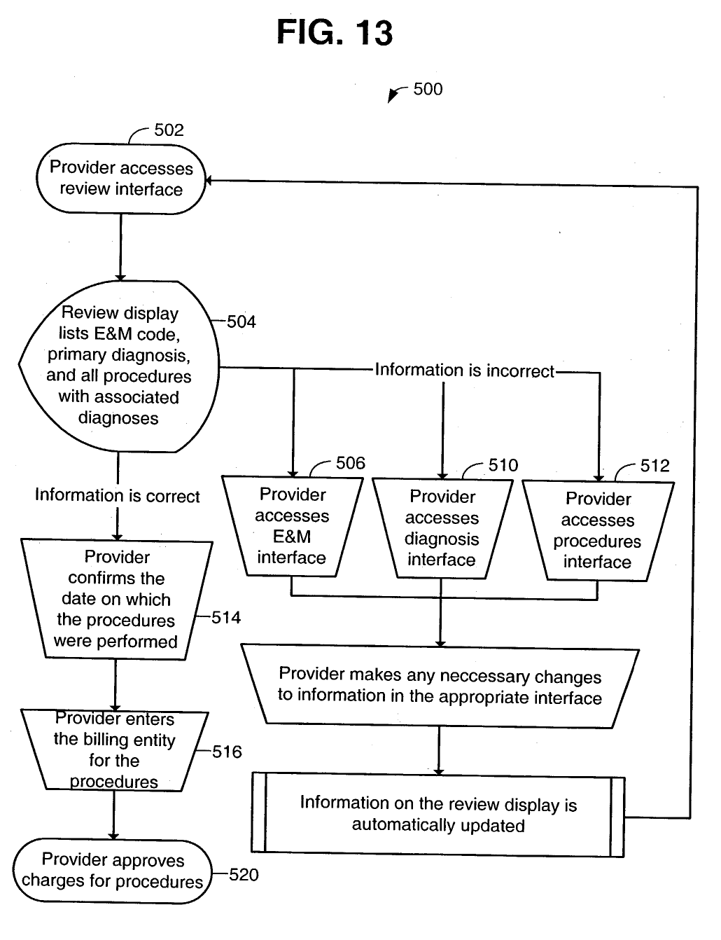

FIG. 13 is a flowchart 500 illustrating a review and a charge capture. As a part of the charge capture process, the provider accesses the interface used to review and accept the charges (block 502).

The review interface presents a summary of the information entered in the previous interfaces (block 504). The provider can inspect this summary to verify that the information recorded is accurate. If the provider chooses to do so, the provider may return to any of the previous interfaces to re-compute LOS (block 506), edit the list of diagnoses (block 510), or edit the list of procedures (block 512). The provider may also specify the date when the service was provided, and the billing entity in which it was provided.

Once the information is correct, the provider is prompted to confirm the date on which the procedures were performed (block 514) and select a department to be billed for the charges (block 516). Once this information is entered, the provider may approve the charges (block 520). As illustrated in FIG. 8, this information is entered in the UPR when the handheld data is synchronized with the UPR.

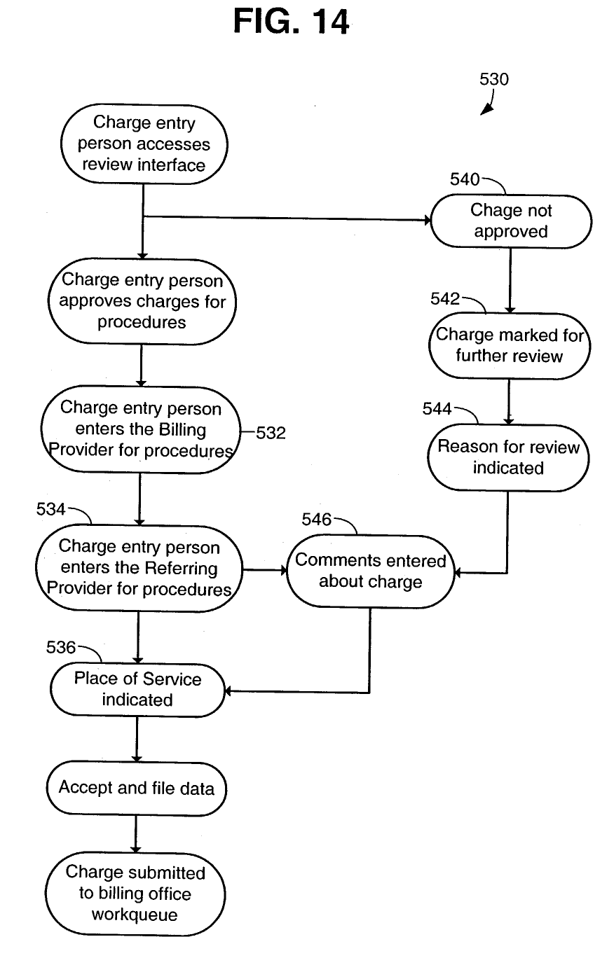

FIG. 14 is a flowchart 530 illustrating the entering of additional billing information. During charge review, the user entering the charge may need to enter additional billing related information. For example, the following pieces of information are commonly collected for a charge: (1) billing provider—this would be collected if someone other than the provider who rendered the service is entering charges on behalf of that provider (block 532); (2) referring provider—this would be collected if there was one provider who asked another to perform a service (block 534); and (3) place of service—physical location where the patient was seen (block 536).

Additionally, if the user entering charges cannot approve them without further review, he may indicate that as well (block 540). For example, the following may be collected if a charge needs further review: (1) please review charge—if this were indicated, then the charge would be moved to a billing work queue for later review. This would only happen if the user were unsure of whether to accept the charges (block 542); (2) reason for review—if the user indicated that charge needs further review, then he might be asked to give a reason. For example, the diagnosis needed was not found, the procedure needed was not found, the service was related to worker's comp, etc (block 544); and (3) comments—these would be optionally entered by the user if he wanted to provide extra information about the charge, such as why it was marked as needing review (block 546).

Although the techniques for managing the interaction between machine-generated patient lists and user-defined patient lists and capturing charges, described herein, are preferably implemented in software, they may be implemented in hardware, firmware, etc., and may be implemented by any other processor associated with the healthcare facilities. Thus, the routine(s) described herein may be implemented in a standard multi-purpose CPU or on specifically designed hardware or firmware as desired. When implemented in software, the software routine(s) may be stored in any computer readable memory such as on a magnetic disk, a laser disk, or other storage medium, in a RAM or ROM of a computer or processor, etc. Likewise, the software may be delivered to a user or process control system via any known or desired delivery method including, for example, on a computer readable disk or other transportable computer storage mechanism or over a communication channel such as a telephone line, the Internet, etc. (which are viewed as being the same as or interchangeable with providing such software via transportable storage medium).

While the present invention has been described with reference to specific examples, which are intended to be illustrative only and not to be limiting of the invention, it will be apparent to those of ordinary skill in the art that changes, additions or deletions may be made to the disclosed embodiments without departing from the spirit and scope of the invention.

What is claimed is:

1. A method of managing a user-defined patient list in a healthcare setting comprising:
retrieving a plurality of patients from a health record repository to create a master patient list;
retrieving a machine-generated patient list from a first memory, the machine-generated patient list being derived from the master patient list;
retrieving the user-defined patient list from a second memory, the user-defined patient list being derived from the machine-generated patient list;
comparing the machine-generated patient list to the user-defined patient list;
modifying a patient entry on the user-defined patient list in response to the comparison in order to reconcile a difference between the machine-generated patient list and the user defined patient list.

2. The method of claim 1, wherein modifying the patient entry comprises adding a new patient to the user-defined patient list if the new patient is on the machine-generated patient list but not on the user-defined patient list.

3. The method of claim 2, wherein adding the new patient is performed only if the new patient is not a user-added patient.

4. The method of claim 1, wherein modifying the patient entry comprises retaining a previous patient from the user-defined patient list if the previous patient is on the user-defined patient list but is not on the machine-generated patient list and if the patient is a user-added patient.

5. The method of claim 1, further comprising checking an attribute associated with the patient.

6. The method of claim 5, wherein modifying the patient entry comprises retaining the previous patient from the user-defined patient list if the previous patient is on the user-defined patient list but is not on the machine-generated patient list and if the attribute is negative.

7. The method of claim 5, wherein modifying the patient entry comprises retaining the previous patient from the user-defined patient list if the previous patient is on the user-defined patient list but is not on the machine-generated patient list, and if the attribute is positive, and if the previous patient was not a user-added patient.

8. The method of claim 5, wherein modifying the patient entry comprises removing the previous patient from the user-defined patient list if the previous patient is on the user-defined patient list but is not on the machine-generated patient list, and if the previous patient was not a user-added patient, and if the attribute is positive.

9. The method of claim 1, wherein retrieving the user-defined patient list comprises retrieving the user-defined patient list from the first memory, as the second memory is the first memory.

10. A method of managing a user-defined patient list in a healthcare setting comprising:
retrieving a plurality of patients from a database to create a master patient list;
retrieving a machine-generated patient list from a first memory, the machine-generated patient list being derived from the master patient list;
retrieving the user-defined patient list from a second memory, the user-defined patient list being derived from the machine-generated patient list;
comparing the machine-generated patient to list the user-defined patient list;
adding a new patient to the user-defined patient list if the new patient is on the machine-generated patient list but not on the user-defined patient list and if the new patient is not a user-added patient;
checking an attribute from a previous patient's electronic medical record;
retaining the previous patient from the user-defined patient list if the previous patient is on the user-defined patient list but is not on the machine-generated patient list and if the attribute is negative; and
retaining the previous patient from the user-defined patient list if the previous patient is on the user-defined patient list but is not on the machine-generated patient list, and if the attribute is positive, and if the previous patient was not a user-added patient.

11. The method of claim 10, comprising allowing the user to add a patient to the user-defined patient list by selecting the patient on the master patient list.

12. The method of claim 10, comprising allowing the user to remove a patient from the user-defined patient list by selecting the patient on the user defined patient list.

13. The method of claim 10, comprising querying the user regarding an action that may be taken for the previous patient with the positive attribute.

14. The method of claim 10, wherein checking the attribute comprises determining if a charge has been captured for the previous patient, and wherein a positive attribute indicates that a charge has been captured for the previous patient.

15. The method of claim 10, wherein the first memory is the second memory.

16. The method of claim 10, wherein the first memory is different from the second memory.

17. A method of managing a user-defined patient list in a healthcare setting comprising:
retrieving a plurality of patients to create a master patient list;
retrieving a machine-generated patient list from a first memory, the machine-generated patient list being derived from the master patient list;
retrieving the user-defined patient list from a second memory, the user-defined patient list being derived from the machine-generated patient list;
comparing the user-defined patient list to the machine-generated patient list;
adding a new patient to the user-defined patient list if the new patient is on the machine-generated patient list but not on the user-defined patient list;
retaining a previous patient from the user-defined patient list if the previous patient is on the user-defined patient list but is not on the machine-generated patient list and if the patient is a user-added patient;
checking an attribute associated with the patient if the previous patient is on the user-defined patient list but is not on the machine-generated patient list; and
removing the previous patient from the user-defined patient list if the previous patient is on the user-defined patient list but is not on the machine-generated patient list, and if the previous patient was not a user-added patient, and if the attribute is positive.

18. The method of claim 17, comprising allowing the user to add a patient to the user-defined patient list by selecting the patient on the master patient list.

19. The method of claim 17, comprising querying the user regarding an action that may be taken for the previous patient with a negative attribute.

20. The method of claim 17, wherein checking the attribute comprises determining if a charge has been captured for the previous patient, and wherein the positive attribute indicates that a charge was captured for the previous patient.

21. The method of claim 17, comprising checking a system setting to determine if the user added patient should be retained on the user-defined patient list regardless of the patient's status.

22. The method of claim 17, wherein the first memory is the second memory.

23. The method of claim 17, wherein the first memory is different from the second memory.

24. A method of managing a rounding list in a healthcare setting comprising:
retrieving a plurality of patients from a repository to create a master patient list;
retrieving an attending list from a first memory, the attending list including a plurality of patients associated with an attending provider and being derived from the master patient list;
retrieving the rounding list from a second memory, the rounding list being a personal rounding list for the attending provider and being derived from the attending list;
comparing the rounding list to the attending list;
adding a new patient to the rounding list if the new patient is on the attending list but not on the rounding list;
removing a previous patient from the rounding list if the previous patient is on the rounding list but not on the attending list and if the previous patient was not a user-added patient; and
retaining the previous patient on the rounding list if the previous patient is on the rounding list but not on the attending list, and if the previous patient was a user-added patient, and if a setting exists to retain all user-added patients on the rounding list.

25. The method of claim 24, comprising allowing the attending provider to add a patient to the rounding list by selecting the patient on the master patient list.

26. The method of claim 24, comprising allowing the attending provider to remove a patient from the rounding list by selecting the patient on the rounding list.

27. The method of claim 24, wherein retrieving the plurality of patients from the repository comprises retrieving a hospital census.

28. The method of claim 24, comprising determining if a charge has been captured for the previous patient.

29. The method of claim 28, comprising removing the previous patient from the rounding list if the charge for the previous patient has been captured.

30. The method of claim 28, comprising retaining the previous patient on the rounding list if the charge for the previous patient has not been captured.

31. The method of claim 24, wherein the first memory is the second memory.

32. A system for managing a rounding list in a healthcare setting comprising:
means for retrieving a plurality of patients to create a master patient list;
means for retrieving an attending list from a first memory, the attending list including a plurality of patients associated with an attending provider and being derived from the master patient list;
means for retrieving the rounding list from a second memory, the rounding list being a personal rounding list for the attending provider and being derived from the attending list;
means for comparing the rounding list to the attending list;
means for adding a new patient to the rounding list if the new patient is on the attending list but not on the rounding list;
means for removing a previous patient from the rounding list if the previous patient is on the rounding list but not on the attending list and if the previous patient was not a user-added patient; and
means for retaining the previous patient on the rounding list if the previous patient is on the rounding list but not on the attending list, and if the previous patient was a user-added patient.

33. The system of claim 32; comprising a means for allowing the attending provider to add a patient to the rounding list by selecting the patient on the master patient list.

34. The system of claim 32, comprising a means for allowing the attending provider to remove a patient from the rounding list by selecting the patient on the rounding list.

35. The system of claim 32, comprising a means for determining if a charge has been captured the previous patient.

36. The system of claim 35, comprising a means for retaining the previous patient on the rounding list if the charge has been captured for the previous patient.

37. The system of claim 32, comprising a means for checking an attribute associated with the patient.

38. The system of claim 37, comprising a means for querying the attending provider regarding an action that may be taken for the previous patient with a negative attribute.

39. The system of claim 32, comprising means for retaining the previous patient on the rounding list only if a setting exists to retain all user-added patients on the rounding list

40. An article comprising a machine-accessible medium having stored thereon instructions that, when executed by a machine, cause the machine to:
retrieve a plurality of patients: from a repository to create a master patient list;
retrieve an attending list from a first memory, the attending list including a plurality of patients associated with an attending provider and derived from the master patient list;
retrieve the rounding list from a second memory, the rounding list being a personal rounding list for the attending provider and derived from the attending list;
compare the rounding list to the attending list;
add a new patient to the rounding list if the new patient is on the attending list but not on the rounding list;
remove a previous patient from the rounding list if the previous patient is on the rounding list but not on the attending list and if the previous patient was not a user-added patient; and
retain the previous patient on the rounding list if the previous patient is on the rounding list but not on the attending list, and if the previous patient was a user-added patient, and if a setting exists to retain all user-added patients on the rounding list.

41. The article of claim 40, having further instructions that, when executed by the machine, cause the machine to allow the attending provider to add a patient to the rounding list by selecting the patient on the master patient list.

42. The article of claim 40, having further instructions that, when executed by the machine, cause the machine to allow the attending provider to remove a patient from the rounding list by selecting the patient on the rounding list.

43. The article of claim 40, having further instructions that, when executed by the machine, cause the machine to determine if a charge has been captured for the previous patient.

44. The article of claim 43, having further instructions that, when executed by the machine, cause the machine to remove the previous patient from the rounding list only when the charge has been captured for the previous patient.

45. The article of claim 43, having further instructions that, when executed by the machine, cause the machine to retain the previous patient on the rounding list if the charge has not been capturee for the previous patient.
